(19) United States
(12) Patent Application Publication
(10) Pub. No.: US 2004/0027392 A1
(43) Pub. Date: Feb. 12, 2004

(54) System and method for quick access of computer resources to control and configure a computer

(76) Inventors: Loren S. Dunn, Spring, TX (US); Mark E. Baerenstecher, Tomball, TX (US); Christopher W. Larsen, Tomball, TX (US); Lan Wang, Cypress, TX (US); Minh H. Do, Tomball, TX (US); Vali Ali, Houston, TX (US)

Correspondence Address: Michael G. Fletcher, Fletcher, Yoder & Van Someren, P.O. Box 692289, Houston, TX, 77269-2289, US

(21) Appl. No.: 10/215,416

(22) Filed: Aug. 8, 2002

(51) Int. Cl. G09G 5/00

(52) U.S. Cl. 345/810

(57) ABSTRACT

The present technique provides a system and method for quickly accessing, configuring, and controlling computer resources, such as hardware components and software applications of a computing device. A resource control menu is provided with controls, such as links to configuration utilities, for a plurality of resources of the computing device. In operation, a user launches the resource control menu by performing a launching action, such as a single button click. The user then controls the desired resource by selecting one of the controls from the resource control menu.

### FIELD OF THE INVENTION

The present technique relates generally to computer systems and, more particularly, to control and management systems for resources of computer systems. The present technique provides a system and method for quickly accessing, configuring, and controlling a plurality of computer resources, such as hardware components and software applications of a computing device.

### BACKGROUND OF THE INVENTION

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Computer systems, such as desktop or laptop computers, generally have a variety of utilities to configure and control the system resources. For example, a particular computer system may have a hardware or software-based control mechanism for the audio volume, the video contrast and brightness, the power properties, and various other hardware and software resources. Unfortunately, the various control mechanisms are disposed in different locations throughout the computer system. In desktop and laptop computers, a special function key on the keyboard may be used to launch a particular application or hardware control, such as the audio volume. However, some computer systems, such as tablet computers, may not have a conventional keyboard or mouse.

### BRIEF DESCRIPTION OF THE DRAWINGS

Exemplary embodiments will hereafter be described with reference to the accompanying drawings, wherein like reference numerals denote like elements, and:

FIG. 1 is a perspective view of an exemplary tablet computer system having a tablet computing device, a multi-attachable keyboard, a digitizing pointing device, and a multi-configurable docking assembly;

FIG. 2a is a bottom view of the tablet computing device of FIG. 1;

FIGS. 2b-2e are side views of the tablet computing device of FIG. 1;

FIG. 2f is a top view of the tablet computing device of FIG. 1;

FIG. 3 is a top view of the tablet computing device of FIG. 1 illustrating interaction between the digitizing pointing device and one of multiple digitizer buttons within the tablet computing device;

FIG. 4 is a partial internal perspective view of the tablet computing device of FIG. 1 illustrating a digitizer assembly for the digitizer buttons illustrated by FIG. 3;

FIG. 5 is a cross-sectional side view of the digitizer assembly illustrated in FIG. 4;

FIGS. 6a and 6b are cross-sectional side views of the digitizing pointing device of FIG. 3 illustrating internal circuitry and switch mechanisms for interaction with the digitizer assembly of FIGS. 4 and 5;

FIG. 7 is a top view of the tablet computing device of FIG. 1 having a resource control menu interactive with the digitizing pointing device;

FIG. 8 is a diagrammatical illustration of an exemplary embodiment of the resource control menu illustrated by FIG. 7;

FIG. 9 is a diagrammatical illustration of an exemplary menu configuration panel for the resource control menu illustrated by FIG. 7;

FIG. 10 is a flowchart illustrating an exemplary resource configuration process of the present technique; and

FIG. 11 is a flowchart illustrating an exemplary quick resource access and control process of the present technique.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present technique is directed toward a tablet computer system and, more specifically, systems and methods for quickly accessing and configuring hardware and other system resources. As described in detail below, the present technique organizes controls for a plurality of system resources into a single interface, such as a resource control menu, which minimizes the number of user actions to configure and control those system resources. For example, the resource control menu may be provided with controls, such as links to configuration utilities, for a plurality of resources of the computing device. In operation, a user launches the resource control menu by performing a launching action, such as a single button click or another simple user action. For example, the system may have a variety of quick-access mechanisms, such as a voice command or a button disposed in a continuously accessible location during operation of the system. The user then controls the desired resource by selecting one of the controls from the resource control menu.

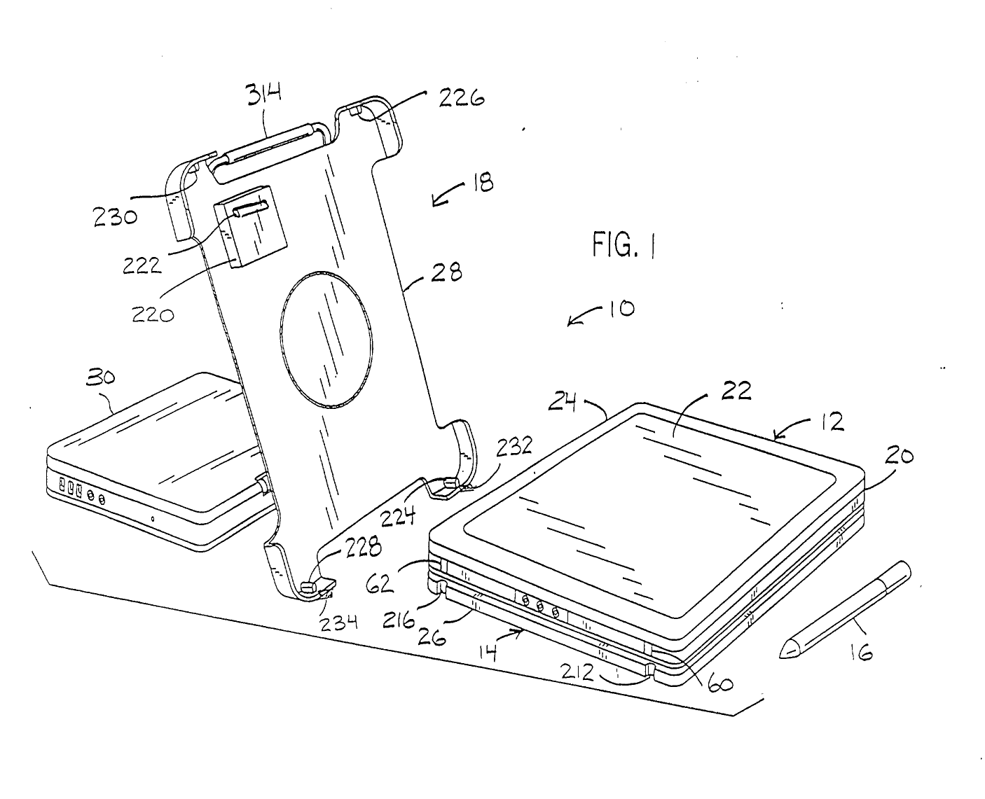

FIG. 1 is a perspective view of an exemplary tablet computer system 10 of the present technique. In this exemplary embodiment, the tablet computer system 10 comprises a tablet computing device 12, a multi-attachable keyboard 14, a digitizing pointing device 16, and a multi-configurable docking assembly 18. However, the tablet computer system 10 may comprise any other suitable components or peripherals, or it may simply comprise the tablet computing device 12. The foregoing components are intended to provide a relatively flexible and multi-configurable computing system, which allows multiple angular, elevational, and orientational positions of the various components of the table computing system 10. Accordingly, a user may select the desired components and adapt the tablet computing system 10 to a desired environment, such as a variety of home, work, and mobile environments. Although not illustrated, the tablet computer system 10 also may comprise a variety of additional components and peripherals, such as a printer, a scanner, a digital camera, an external monitor, and various other input/output devices.

As illustrated, the tablet computing device 12 has a housing 20, which has a display screen assembly 22 disposed in a top side 24 of the housing 20, a plurality of computing components and circuitry disposed within the housing 20, and the multi-attachable keyboard 14 removably coupled to a bottom side 26 of the housing 20. The display screen assembly 22 may comprise any suitable flat panel display screen technology, including a variety of screen enhancement, antireflective, protective, and other layers. The display screen assembly 22 also may have touch panel technology, digitizer panel technology, and/or various other user-interactive screen technologies. As discussed in detail below, the digitizing pointing device 16 interacts with a digitizing panel 136 disposed in the top side 24 of the tablet computing device 12 (see FIG. 3). The digitizing panel may be disposed below, within, or adjacent the display screen assembly 22. In this exemplary embodiment, the digitizing panel 136 extends to a peripheral area of the display screen assembly 22, where the tablet computing device 12 defines digitizer-activated buttons for desired computing functions. The tablet computing device 12 also may comprise a variety of user interaction circuitry and software, such as speech-to-text conversion software (i.e., voice recognition) and writing-to-text conversion software (e.g., for the digitizing pointing device 16). Accordingly, a user may interact with the tablet computing device 12 without a conventional keyboard or mouse.

The computing components disposed within the tablet style housing 20 may comprise a processor, a motherboard, volatile and nonvolatile memory (e.g., a hard drive, RAM, ROM, flash memory, cache memory, etc.), network circuitry (e.g., a modem, a network card, etc.), wireless communications circuitry (e.g., IR, RF, optical, blue tooth, and other technologies), input/output ports, audio/video circuitry, and various other circuitry, components, and component receptacles/bays. For example, the tablet computing device 12 and the multi-attachable keyboard 14 may comprise wireless communications circuitry, such as RF circuitry, such that a user may interact with the tablet computing device 12 remotely. Moreover, the tablet computing system 10 may comprise a wireless microphone or wireless voice recognition headset to facilitate wireless user-interaction.

The multi-attachable keyboard 14 is attachable/detachable to the tablet computing device 12 in a variety of operable and storage locations, such as the storage location illustrated by FIG. 1. In each operable and storage location, the multi-attachable keyboard 14 also may be attachable/detachable in multiple orientations, which may be positionally securable or movable by a linear or rotational positioning assembly. However, the present technique provides a variety of attachment alignment structures to prevent undesirable or destructive coupling, or movement, of the tablet computing device 12 and the multi-attachable keyboard 14. In the storage attachment configuration of FIG. 1, the multi-attachable keyboard 14 may be coupled to the bottom side 26 of the tablet computing device 12 in a variety of configurations, such as keyboard-side facing inward or outward from the bottom side 26. However, in this exemplary embodiment, the tablet computing device 12 and the multi-attachable keyboard 14 comprise intercoupling structures to position and align the multi-attachable keyboard 14 such that the keyboard-side faces inward toward the bottom side 26. Accordingly, buttons and other physically movable user-interaction components of the multi-attachable keyboard 14 are protected in the stored keyboard position illustrated by FIG. 1. In operation, the keyboard-side of the multi-attachable keyboard 14 is accessible during user-interaction with the display screen assembly 22 of the tablet computing device 12.

The tablet computing device 12 and the multi-attachable keyboard 14 may be jointly or separately attachable to the multi-configurable docking assembly 18 at a support section 28, which is movably coupled to a base section 30. As described below, the support section 28 may be movable to a variety of angles, elevations, and orientations to enhance the user's interaction with the tablet computing device 12. For example, the support section 28 may be rotatable between portrait and landscape orientations and between horizontal and upright orientations. The tablet computer system 10 also may comprise a screen orientation switching mechanism, which may operate automatically or manually to switch the display orientation of the display screen assembly 22 between portrait and landscape orientations. Accordingly, as discussed in further detail below, the multi-configurable docking assembly 18 may trigger an automatic change in the viewing orientation upon moving the support section 28 between the portrait and landscape orientations, while the tablet computing device 12 is disposed in the docked configuration. This automatic switching mechanism reduces the user's tasks and ensures that text/images are always displayed in an upright/readable orientation for the user regardless of the physical orientation of the tablet computing device 12.

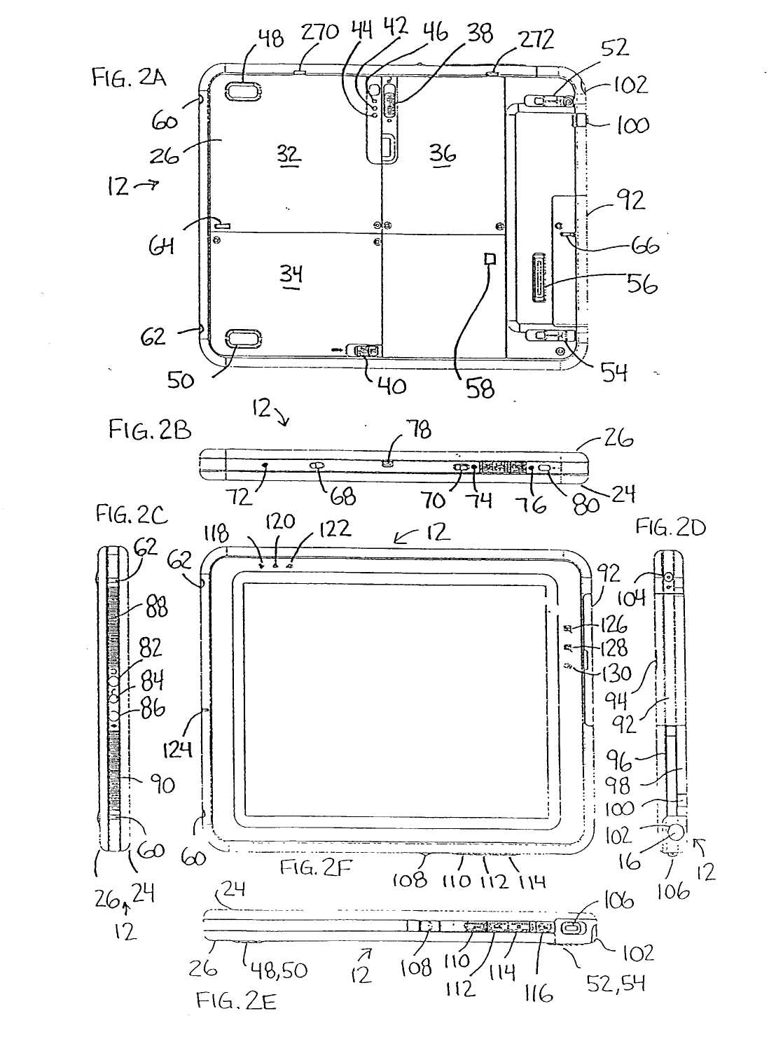

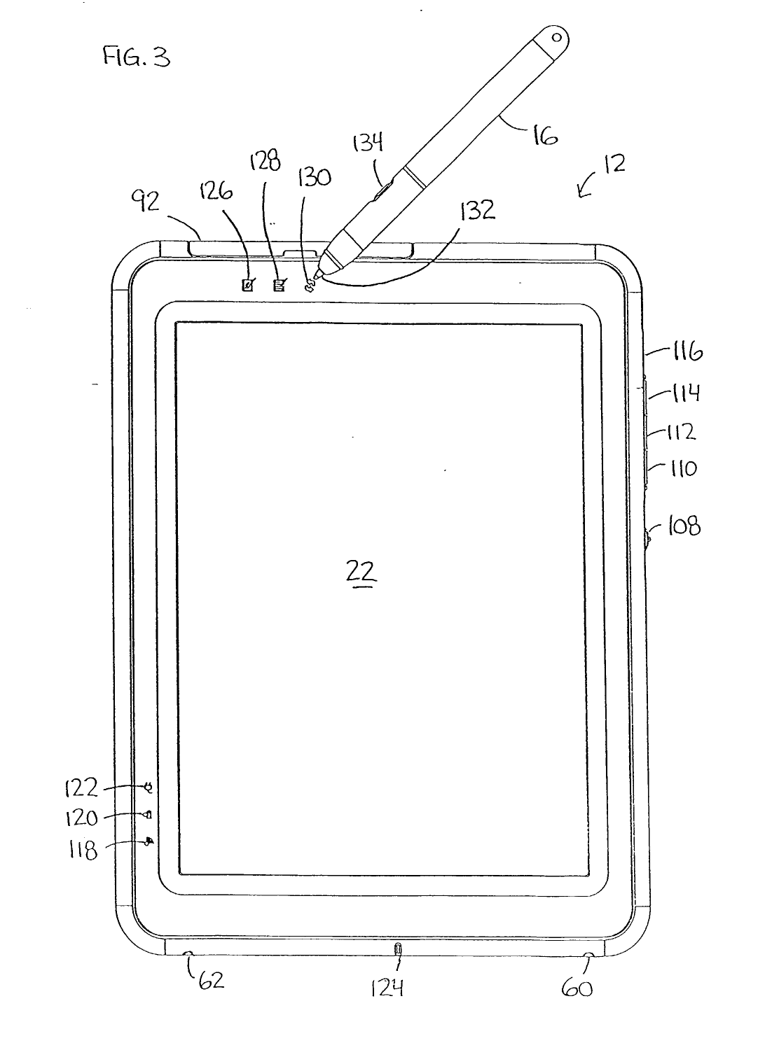

The tablet computing device 12 is further illustrated with reference to FIGS. 2-5. As illustrated by FIGS. 2a-2f, the tablet computing device 12 may have a variety of computing components and circuitry, input/output ports, functional buttons, status indicators, security mechanisms, component attachment mechanisms, component receptacles, and expansion slots. Although specific features and components are described in detail below, the present technique may utilize any suitable technology or components.

FIG. 2a is a bottom view of the tablet computing device 12. As illustrated, the bottom side 26 has a plurality of component bays, such as bays 32, 34, and 36, which may house a battery, a hard drive, memory (e.g., RAM), or any other desired devices. The tablet computing device 12 also may have one or more device lock/release mechanisms to secure internal and external devices, such as the multi-attachable keyboard 14, a display screen cover assembly, a carrying handle, a battery, removable memory, or other such components. As illustrated, the tablet computing device 12 has an internal device lock/release mechanism 38 for one or more of the components disposed within the bays 32, 34, and 36. The tablet computing device 12 also has an external device lock/release mechanism 40, which is operable to lock and release the multi-attachable keyboard 14, a protective display screen cover, and other desired devices with external device mounting structures on the tablet computing device 12. Component test buttons and status indicators also may be provided to analyze one or more components, such as the components internally or externally secured to the tablet computing device 12 via the mechanisms 38 and 40. For example, the tablet computing device 12 has a component test button 42 and status buttons 44 and 46, which may be configured for analyzing the battery, the keyboard 14, or any other desired device.

As mentioned above, the tablet computing device 12 is configured for a standalone or a docked configuration in a plurality of orientations, such as portrait and landscape orientations in various angles relative to a support surface. For example, the computing device 12 may comprise a plurality of feet to mount the tablet computing device 12 onto a desired surface, such as a desktop, a wall, a user's lap, or any other support surface. In this exemplary embodiment, the tablet computing device 12 includes rubber feet 48 and 50 and adjustable feet 52 and 54, which may comprise any suitable height adjustment and locking mechanism (e.g., a flip-up mechanism with a slot-tab securement structure). For a docked configuration, the tablet computing device 12 comprises a docking connector 56 and a docking latch structure 58, which are intercoupleable with mating connector and latch structures on the multi-configurable docking assembly 18. As noted above, the tablet computing device 12 also may comprise one or more mounting alignment structures, such as docking alignment slots 60 and 62, which are intercoupleable in a single alignment orientation with mating alignment structures on the multi-configurable docking assembly 18. Similarly, alignment structures 64 and 66 may be disposed on the bottom side 26 of the tablet computing device 12 to align the keyboard 14, or other face-mountable devices, in a proper mount orientation with the tablet computing device 12. Moreover, the keyboard 14 or other face-mountable devices may be removably intercoupled with the bottom side 26 via the docking latch structure 58 or an edge-based latch mechanism.

FIG. 2b is a side view of the tablet computing device 12 illustrating such an edge based latch mechanism. As illustrated, the tablet computing device 12 has external device mount structures 68 and 70, which may comprise elongated slots having internal latch mechanisms. For example, the external device lock/release mechanism 40 may be moved to position slot-housed hook members between released and latched positions. Again, the tablet computing device 12 may have one or more attachment alignment mechanisms, such as alignment structures 72, 74, and 76, to ensure the proper attachment orientation of the external device, such as the multi-attachable keyboard 14 or a protective display cover. Accordingly, the alignment structure 72 is paired with the external device mount structure 68 and the alignment structures 74 and 76 are paired with the external device mount structure 70, such that a single mount orientation is supported.

One or more input/output ports also may be provided on the tablet computing device 12 to facilitate data exchange and communication with external devices or networks. For example, the tablet computing device 12 may have a communications port 78 in an accessible position relative to the external device mount structures 68 and 70. Accordingly, an external device mounted to the tablet computing device 12 is able to communicate with the tablet computing device 12 via the communications port 78, which may comprise any suitable port. For example, the port 78 may be a serial port, a parallel port, a USB port, a wireless port, an optical port, or any other desired port. The port 78 also may comprise hot-plugging technology to facilitate attachment and detachment during operation of the tablet computing device 12.

Security features also may be provided on various components of the tablet computer system 10. The system 10 may have one or more Kensington locks or other physical securement mechanisms for physically securing the various components to a desired fixture. For example, each of the components illustrated by FIG. 1 may comprise a security slot, which is intercoupleable with a cable lock. Moreover, the components of the present technique may comprise multi-stage locks that provide an option to intercouple the components jointly or separately to a desired fixture using a single lock mechanism. As illustrated by FIG. 2b, the tablet computing device 12 has a lock mechanism 80, such as a Kensington lock slot. The multi-attachable keyboard 14, the digitizing pointing device 16, and the multi-configurable docking assembly 18 may have similar lock mechanisms.

As illustrated by FIG. 2c, the tablet computing device 12 also may comprise a plurality of audio circuitry, such as audio ports 82, 84, and 86 and speakers 88 and 90. For example, the audio ports 82, 84, and 86 may comprise a headphone port, a cell phone port, and a microphone port, respectively. The tablet computing device 12 also may comprise a variety of video circuitry, such as a video input port, a video output port, and video processing circuitry for display on the display screen assembly 22 or an external monitor.

The tablet computing device 12 also may have one or more communications port panels, which may be exposed or concealable by a removable port panel cover. For example, as illustrated by FIG. 2d, the tablet computing device 12 has a flexible port panel door 92, which is rotatable away from the tablet computing device 12 to provide access to one or more communications ports or devices, such as serial, parallel, USB, or other ports. The flexible port panel door 92 also has a tool free latch mechanism 94, which removably couples a movable portion of the door 92 to the tablet computing device 12.

As illustrated by FIG. 2d, the tablet computing device 12 also may have a variety of edge-based component bays or receptacles, such as component receptacles 96, 98, 100, and 102. For example, the component receptacle 96 may house a PCMCIA device, such as a network card or an audio/video card. The component receptacle 98 may support a memory card, such as flash memory or other desired memory. In the illustrated embodiment, the component receptacle 100 houses a desired attachment for the digitizing pointing device 16, which is removably storable in the component receptacle 102. For example, a tether attachment may be removably disposed in the component receptacle 100.

Power control and management features also may be provided in the tablet computing device 12. As illustrated by FIG. 2d, the tablet computing device 12 may have one or more external power connectors, such as power connector 104, to support AC or DC power sources. The tablet computing device 12 also may have one or more power control buttons, such as power button 106, which may provide on/off, reset, and other power functionality. A power status and battery level indicator also may be incorporated into the tablet computing device 12. Moreover, one or more of the digitizer buttons described below may be associated with power management functions and software.

As mentioned above, a user may interact with the tablet computing device 12 without a conventional keyboard or mouse. As illustrated by FIG. 2e, the tablet computing device 12 may have a variety of control buttons, menu scroll and select mechanisms, and other pointing devices to facilitate user interaction without an external user-interaction device. For example, as illustrated, the tablet computing device 12 may comprise a jog dial 108 and functional buttons 110, 112, 114, and 116. The jog dial 108 may be used to scroll through a software menu, pages of text, or other displayed media. The functional buttons 110-116 may have default hardware or software functions, which the user may program to perform any desired hardware or software task. For example, the functional buttons 110-116 may operate as an ESC key, a TAB key, a CRL-ALT-DEL key combination, a RETURN key, a mouse key, or any standard or special key.

In this exemplary embodiment, one of the functional buttons 110-116 triggers a personal information manager, while another one of the functional buttons 110-116 triggers a quick utilities menu. The personal information manager may comprise a variety of user information and user settings, such as a personal calendar, a phone/address book, an e-mail system and log, a phone system and log, user configuration settings, a user document folder, a personal diary, and any other default or user-selected personal information. The quick utilities menu (i.e., “Q” Utilities) provides access to a variety of software and hardware settings in a quick, or short, menu-based format. Accordingly, the quick utilities menu may list hardware and software items, such as wireless functionality, video output, volume control, mute control, brightness control, contrast control, display orientation functionality (e.g., option to switch between portrait and landscape orientations), power properties, quick menu properties, properties of the tablet computing device 12, properties of the keyboard 14, properties of the digitizing pointing device 16, properties of the docking assembly 18, and a variety of functional buttons, such as PrintScreen, Alt+PrintScreen, and Clt+Alt+Del. The foregoing personal information manager and quick utilities menu also may be triggered by an icon displayed on the display screen assembly 22, by one of the digitizer buttons described below, by a button on the digitizing pointing device 16, by a button on the keyboard 14, by wireless control, by voice commands, or by any other suitable user interaction mechanism.

As illustrated by FIG. 2f, the display screen assembly 22 may occupy most of the area on the top side 24 of the tablet computing device 12. However, the tablet computing device 12 may have a variety of status indicators and user interaction devices disposed about the perimeter of the display screen assembly 22. In the illustrated embodiment, the tablet computing device 12 has status indicators 118, 120, and 122, which may comprise illuminable icons (e.g., LEDs, LCD, etc.) corresponding to the desired devices. For example, the status indicators 118, 120, and 122 may correspond to wireless activity, an AC or DC power source, a low battery level, network connectivity, a system error, processor activity, or any other desired status or activity. The illustrated embodiment also has a microphone 124 disposed in a peripheral portion of the housing 20. Moreover, as described in detail below, the tablet computing device 12 comprises a plurality of digitizer-activated buttons, such as digitizer-activated buttons 126, 128, and 130, which are activated by the digitizing pointing device 16. The foregoing digitizer-activated buttons may be associated with any desired hardware or software functions, such as a screen rotation function, a system status change function (i.e., on/off, reset, logoff, standby, etc.), a dock/undock function, a user-interaction mode (e.g., keyboard, voice recognition, digitizer write-to-text conversion, etc.), a software execution function, a hardware configuration function, or any other such functions. For example, the foregoing digitizer-activated buttons may trigger one or both of the personal information manager or the quick utilities menu described above.

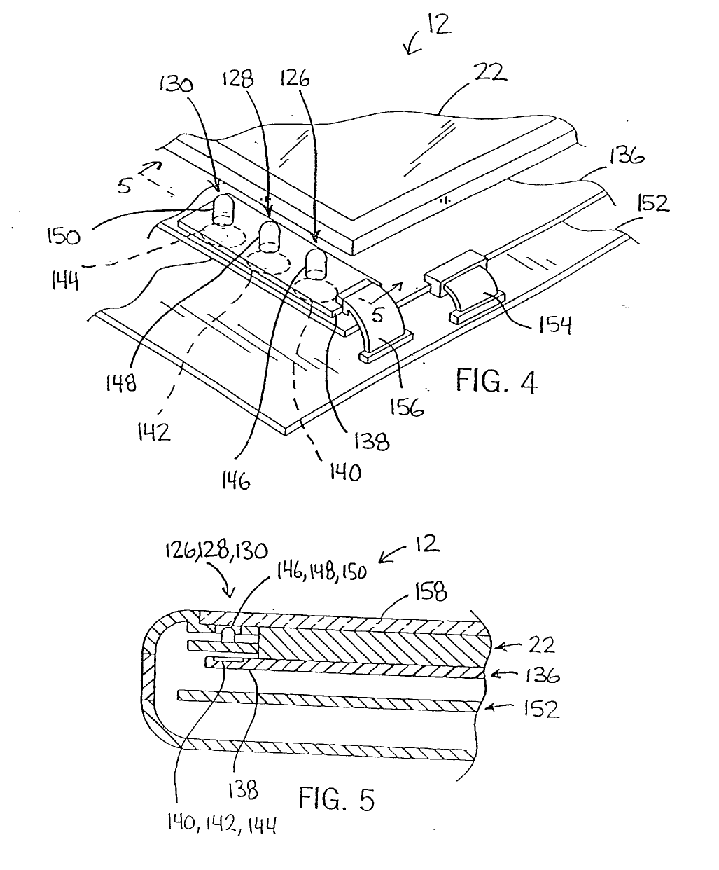

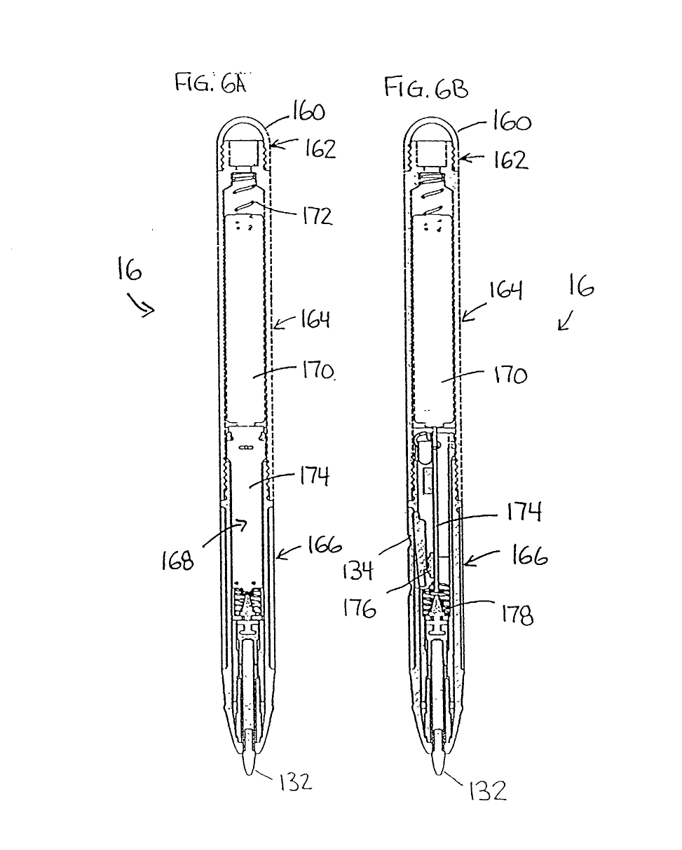

FIG. 3 is a top view of the tablet computing device 12 illustrating interaction between the digitizer-activated buttons 126, 128, and 130 and the digitizing pointing device 16. As illustrated, the digitizing pointing device 16 has a tip 132 and one or more buttons, such as select button 134, to facilitate user interaction with the digitizer-activated buttons 126, 128, and 130. The operation of the digitizer-activated buttons 126, 128, and 130 and the digitizing pointing device 16 is illustrated with reference to FIGS. 4-6. FIG. 4 is an internal perspective view of the tablet computing device 12 illustrating the digitizer-activated buttons 126, 128, and 130. As illustrated, a digitizer panel 136 is disposed below, within, or integral with the display screen assembly 22.

The digitizing pointing device 16 interacts with the digitizer panel 132 throughout the dimensions of the display screen assembly 22 for coordination, selection, writing, and other user-interaction with software displayed on the display screen assembly 22. The digitizer panel 132 and the digitizing pointing device 16 may comprise any suitable digitizer technology, such as electric field, ultrasonic, radio frequency, infrared, electrostatic, electromagnetic, or any other existing or emerging technologies. The digitizer panel 132 and the digitizing pointing device 16 may operate by one-way or two-way signal transmissions, in either direction, between the digitizer panel 132 and the digitizing pointing device 16. In this exemplary embodiment, the digitizing pointing device 16 may transmit a wireless signal, which is sensed by the digitizer panel 132 to coordinate the location of the digitizing pointing device 16. The digitizing pointing device 16 also may transmit one or more secondary signals to trigger a select function or any other desired function. For example, a click of the tip 132 or the button 134 may transmit a secondary signal, which triggers a desired function. Alternatively, the present technique may use touch screen technology, which would facilitate user interaction via a standard pen, a finger, or any suitable pointing item.

The digitizer-activated buttons 126, 128, and 130 are provided in a peripheral region 138 of the digitizer panel 136, which has active button regions 140, 142, 144 defined for each of the buttons 126, 128, and 130, respectively. Each of these active button regions 140, 142, and 144 is associated with a desired hardware/software function, such as a default or user-defined function. The digitizer-activated buttons 126, 128, and 130 also may comprise indicators, such as LEDs 146, 148, and 150, which may be illuminated upon triggering or close proximity of the digitizing pointing device 16. For example, one of the LEDs 146-150 may light up when the tip 132 of the digitizing pointing device 16 is near a desired one of the active button regions 140-144, such that a subsequent triggering event will activate the desired button. The digitizer panel 136 and the indicators 146-150 communicate with a motherboard 152 of the tablet computing device 12 via connectors 154 and 156, respectively.

In operation, the digitizing pointing device 16 may trigger one of the digitizer-activated buttons 126, 128, and 130 by touching the top side 24 of the housing 20 above the desired active button region. Again, the indicators 146-150 may light up when the digitizing pointing device is close enough to activate the desired button. Alternatively, the desired active button region may be selected by engaging a switch mechanism in the tip 132 of the digitizing pointing device 16 (e.g., by tapping the tip 132), while the tip 132 is disposed above the desired active button region. The desired active button region also may be triggered by depressing a button, such as button 134, on the digitizing pointing device 16. The digitizing pointing device 16 also may have a separate button for each of the digitizer activated buttons 126, 128, and 130, such that the desired button may be activated remotely simply by depressing the appropriate button on the pointing device 16. Any other suitable triggering mechanism is also within the scope of the present technique.

As described above, the functional components of the digitizer-activated buttons 126, 128, and 130 are disposed within the housing 20, such that the triggering mechanism is entirely remote from such functional components. As such, the digitizer-activated buttons 126, 128, and 130 are more durable than conventional buttons, which require physical contact directly on the buttons. Moreover, the digitizer-activated buttons 126, 128, and 130 are not subject to accidental activation by a user, such as with conventional physical buttons or touch panel buttons.

FIG. 5 is a partial cross-sectional view of the tablet computing device 12 in the housing region of the digitizer-activated buttons 126, 128, and 130. As illustrated, the display screen assembly 22 comprises a transparent cover panel 158, which extends over a bezel-structure of the housing 20 between the cover panel 158 and the active button regions 140-144 and LEDs 146-150. As mentioned above, the LEDs 146-150 illuminate button icons, or other insignia, in the transparent cover panel 158 upon triggering or active-positioning of the digitizing pointing device 16 relative to the respective active button regions 140-144. Accordingly, the transparent cover panel 158 may be back-painted with one or more materials, such as antireflective or AR coatings, while the button icons or insignia are differentiated to define the digitizer-activated buttons 126, 128, and 130.

FIGS. 6a and 6b are cross-sectional views of the digitizing pointing device 16 illustrating internal switch mechanisms for the tip 132 and the button 134. As illustrated, the digitizing pointing device 16 comprises an elongated housing 160 having a threaded end cap 162, a threaded battery section 164 coupled to the cap 162, and a threaded electronics section 164 coupled to the battery section 164. The threaded electronics section 164 comprises electronic circuitry 168, which is powered by a battery 170 that is biased against the electronic circuitry 168 by a spring 172. As illustrated, the electronic circuitry 168 comprises a printed circuit board 174 having digitizing communications circuitry, a switch 176 for the button 134, and a spring-loaded switch 178 for the tip 132.

In this exemplary embodiment, the digitizing pointing device 16 generates a signal that is received and processed by the digitizer panel 136. For example, the digitizing pointing device 16 may be a digitizer pen produced by FinePoint Innovations, Inc. of Tempe, Ariz. In operation, the signal transmitted from the digitizing pointing device 16 identifies the location of the tip 132 relative to the display screen assembly 22 (and subsurface digitizer panel 136), thereby facilitating pointer movement and drawing functions on the display screen. The digitizing pointing device 16 also may be used to select items, to interact with system software, to activate virtual buttons on the screen, to activate digitizer buttons, or to perform a variety of other functions. For example, one or more special signals may be transmitted from the digitizing pointing device 16 upon activating the switch 176 or the spring-loaded switch 178. Although the illustrated digitizing pointing device 16 is described as a signal-generating digitizer device, any suitable pen and panel digitizer system is within the scope of the present technique. For example, the signal may arise in the digitizer panel 136 rather than the digitizing pointing device 16. The present technique also may use touch screen technology and provide the digitizing pointing device 16 as a “dumb” pointing device.

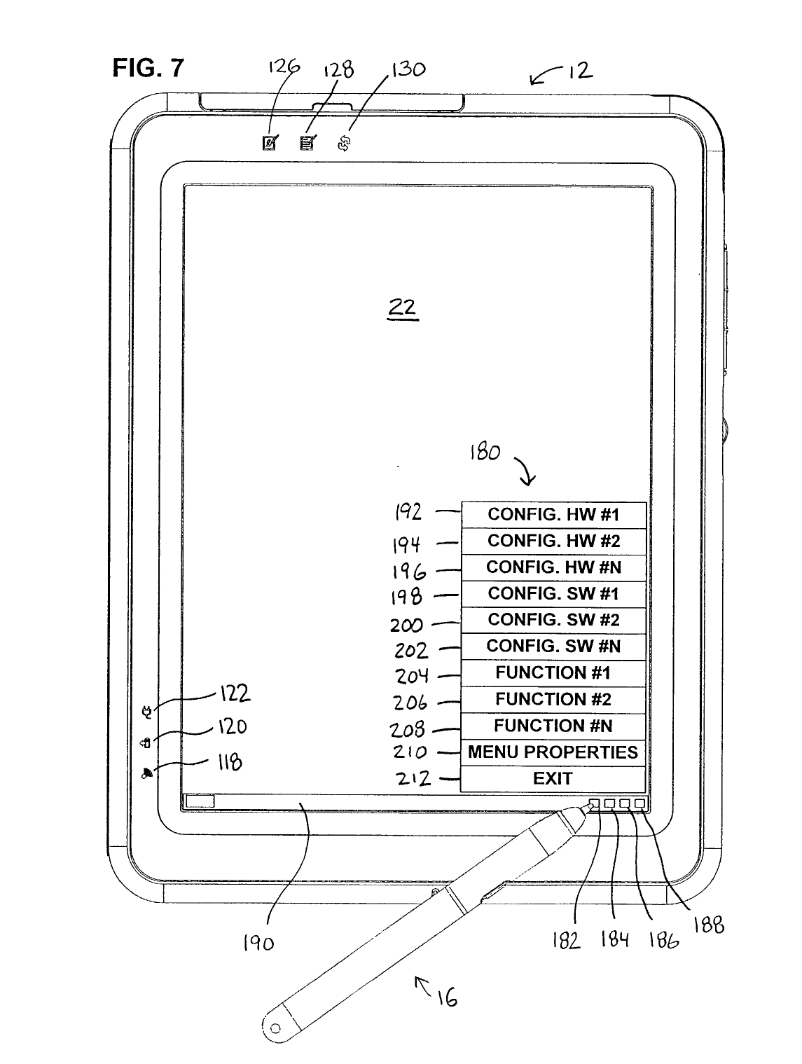

FIG. 7 is a top view of the tablet computing device 12 having a resource control menu 180 listing a variety of hardware and software resources. The user may quickly launch, browse, and interact with the resource control menu 180 using the digitizing pointing device 16, touch-screen buttons, voice commands, electromechanical buttons, software buttons, or any other suitable user interaction mechanisms, such as the jog dial 108 and functional buttons 110, 112, 114, and 116. Each of these user interaction mechanisms may be configured for quick-access and control of the resource control menu 180 during operation of the tablet computing device 12. For example, the user interaction mechanisms may be continually accessible during operation of the tablet computing device 12. If the user interaction mechanism comprises a software button disposed on the display screen 22 of the tablet computing device 12, then the software button may be placed on top of all other applications and software interfaces during operation. Accordingly, the user simply clicks the software button to launch the resource control menu 180. Any other suitable quick-access mechanisms are also within the scope of the present technique.

In this exemplary embodiment, the resource control menu 180 may be displayed on the display screen assembly 22 by activating one of the digitizer-activated buttons 126, 128, and 130, by pressing one of the functional buttons 110, 112, 114, and 116, or by clicking a quick access software button using a suitable pointing device. For example, a plurality of quick access software buttons, such as buttons 182, 184, 186, and 188, may be disposed on a taskbar 190 or in another easily accessible location on the display screen assembly 22. As illustrated, a click of the button 182 (e.g., “Q” Utility button) with the digitizing pointing device 16 opens the resource control menu 180, which has a plurality of resource control menu items.

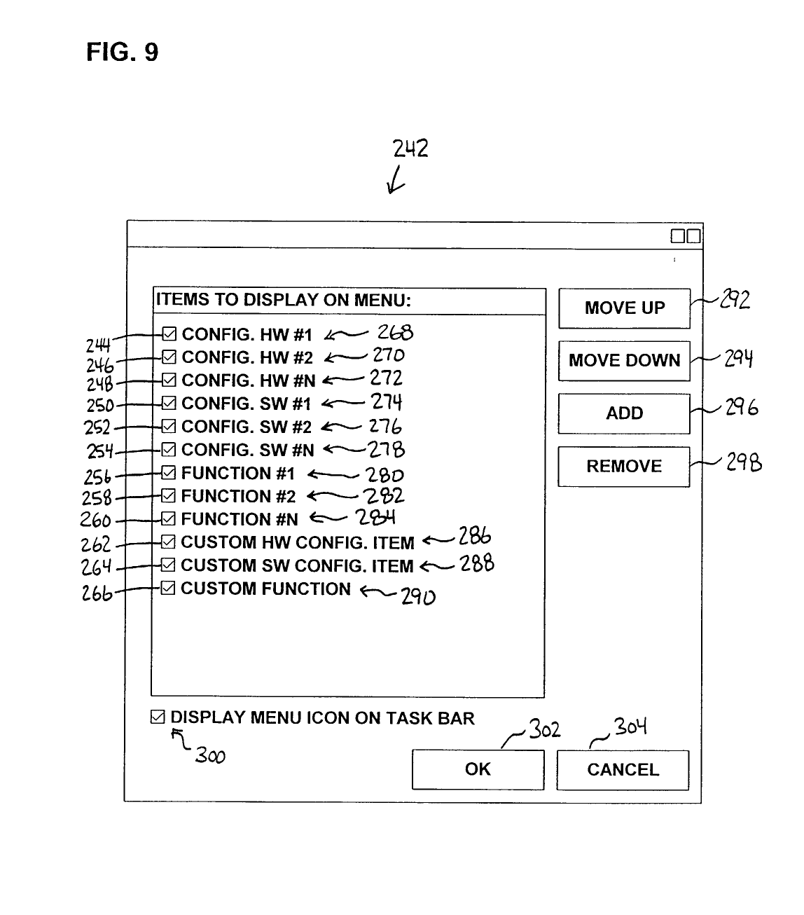

The resource control menu 180 provides quick access or control of a plurality of hardware and software configuration utilities, settings, features, and functions. For example, the resource control menu 180 may comprise menu items 192, 194, and 196 for configuring hardware items #1, #2, and #N, respectively. The resource control menu 180 also may comprise menu items 198, 200, and 202 for configuring or launching software items #1, #2, and #N, respectively. Menu items 204, 206, and 208 also may be provided to execute particular hardware or software functions, such as performing a print screen, closing all applications, or any other desired function. The resource control menu 180 also may have menu items 210 and 212 for launching a menu properties utility (e.g., menu properties panel of FIG. 9) and for closing/exiting the menu 180, respectively. After launching the resource control menu 180, a click of the desired one of the menu items 192-212 launches or executes the corresponding recourse configuration utility or function. Again, the user may select the desired one of the menu items 192-212 using the digitizing pointing device 16, the jog dial 108 and functional buttons 110, 112, 114, and 116, voice command, a touch activated screen mechanism, or any other suitable selection mechanism. Accordingly, the resource control menu 180 provides quick access to a variety of system resources via two button clicks, rather than browsing through various program menus and control panels.

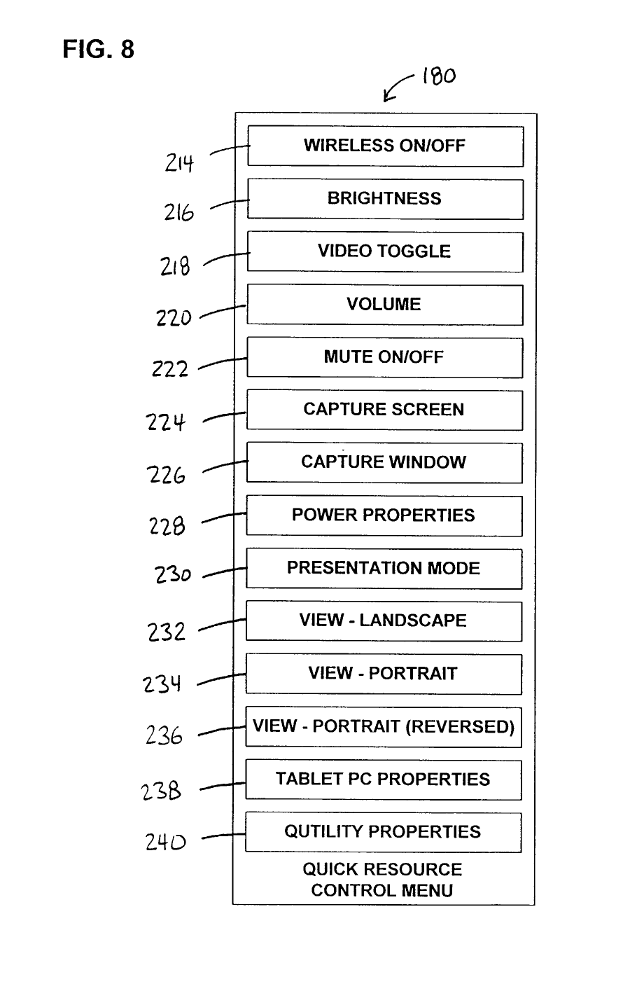

FIG. 8 is a diagrammatical illustration of an exemplary embodiment of the resource control menu 180 illustrated by FIG. 7. In this exemplary embodiment, the resource control menu 180 comprises a wireless on/off button 214, a brightness control button 216, a video toggle button 218, a volume control button 220, a mute on/off button 222, a capture screen button 224, a capture window button 226, a power properties control button 228, a presentation mode control button 230, a view-landscape button 232, a view-portrait button 234, a view-portrait (reversed) button 236, a tablet pc properties button 238, and a menu properties button 240. As mentioned above, each of these buttons 214-240 may initiate a task or launch an existing or custom software application. In this embodiment, a first button click launches the resource control menu 180 and a second button click of a desired one of the buttons 214-240 activates the desired resource control feature.

The wireless on/off button 214 toggles the state of wireless communications circuitry between on and off states. The brightness control button 216 launches a brightness control utility, which allows the user to change the brightness level of the display screen assembly 22. The video toggle button 218 toggles the display mode of the computer system between an internal display mode, an external monitor display mode, and a simultaneous display mode on both the tablet computing device 12 and an external monitor. The volume control button 220 launches a volume control utility, such as the standard volume control panel for the operating system. The mute on/off button 222 toggles the mute setting of the audio output between on and off states. The capture screen button 224 stores the image data of the current screen for subsequent pasting, printing, or other functions. The capture window button 226 similarly stores the image data of the active window. The power properties control button 228 launches a power control utility for the tablet computing device 12. The buttons 232, 234, and 236 change the viewing orientation of the tablet computing device 12 to landscape, portrait, and reversed-portrait viewing orientations to accommodate different physical orientations of the tablet computing device 12. The tablet pc properties button 238 launches a tablet pc configuration utility, which allows the user to change various operational properties of the tablet computing device 12. The menu properties button 240 launches a quick access configuration utility for the resource control menu 180.

FIG. 9 is a diagrammatical illustration of an exemplary menu configuration panel 242 for the resource control menu illustrated by FIG. 7. As illustrated, the menu configuration panel 242 provides an option to display each of a plurality of default and custom items on the resource control menu 180. For example, the menu configuration panel 242 has check boxes 244-260 for default menu items 268-284, which correspond to configuring hardware resources #1, #2, and #N, configuring software resources #1, #2, and #N, and executing hardware/software functions #1, #2, and #N. The menu configuration panel 242 also may have check boxes 262-266 for new/custom menu items 286-290, which correspond to configuring a new/custom hardware resource, configuring a new/custom software resource, and executing a new/custom function. The various default and new/custom menu items may be organized via move up button 292 and move down button 294. Add and remove buttons 296 and 298 are also provided to add new/custom buttons and remove unnecessary buttons from the resource control panel 180. Moreover, the menu configuration panel 222 may provide a variety of menu activation options, such as a check box 300 to display a menu icon (e.g., a quick utilities menu icon) on the task bar 190. The menu configuration panel 242 also may have a variety of other menu options, customizing features for the menu items, and activation features. For example, the menu configuration panel 222 may provide options for voice commands, special key triggers for the menu 180 or specific menu items, interaction with the digitizing pointing device 16, or any other suitable features. If the user accepts the existing and/or modified configuration settings on the menu configuration panel, then the user may click an OK button 302 to apply the configuration settings to the menu 180. Otherwise, the user may click a CANCEL button 304 to retain the existing configuration of the menu 180.

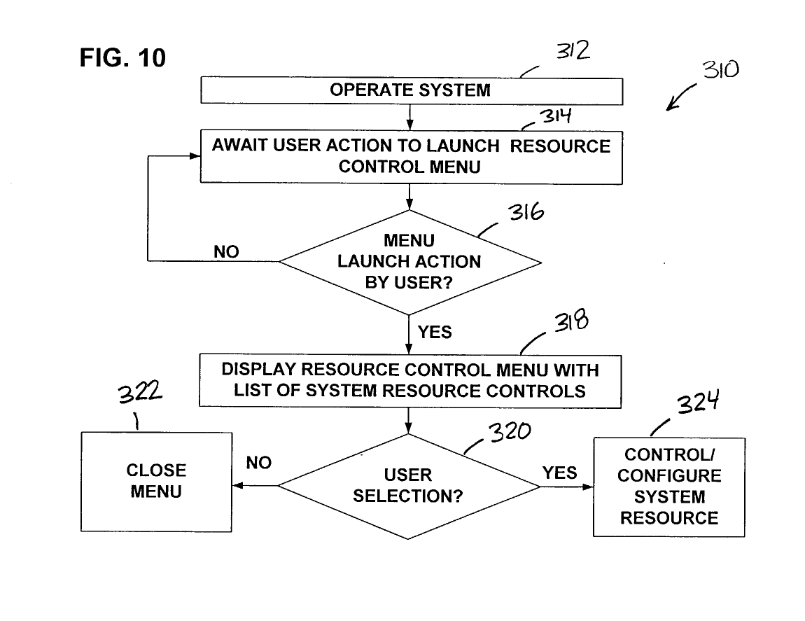

In operation, the foregoing resource control menu 180 and the configuration panel 242 provides quick access to a wide variety of hardware, software, and other system resources. FIG. 10 is a flowchart illustrating an exemplary resource configuration process 310 of the present technique. As illustrated, the process 310 proceeds by operating the system, such as running, starting, or generally operating a desktop, laptop, palmtop, or tablet computer system (block 312). As the system operates, the process 310 awaits an action of the user to launch a resource control menu (block 314). As noted above, the user action may include a voice command, touch of a touch-screen button, touch of an electromechanical button, touch of the digitizing pointing device 16 on a screen button or another digitizer-activated button, or any other menu-launching action by the user. The user action also may be one that is performable at any time during operation of the system. For example, a software button may be disposed continuously above all other software applications to facilitate quick access by the user. If the user performs a suitable menu-launching action at query block 316, then the process 310 displays the resource control menu with a list of system resource controls (block 318). The system resource controls may comprise resource commands, toggles, configuration utilities, or any other suitable controls for a variety of hardware and software components of the system. The process 310 proceeds to control a desired system resource when the user makes a selection from the resource control menu (block 420). If the user does not select a desired resource control at query block 320, then the process 310 closes the resource control menu (block 322). If the user selects a desired resource control at query block 320, then the process 310 proceeds to control or configure the selected system resource as desired by the user (block 324).

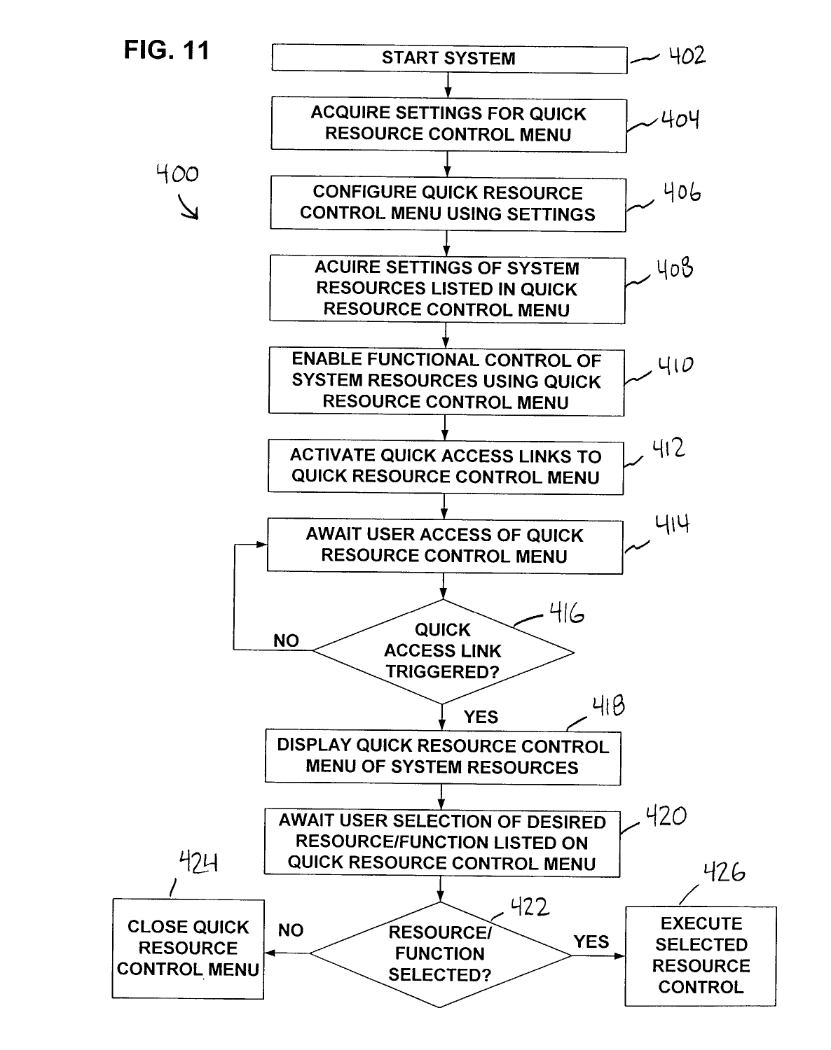

The present technique also may include techniques for gathering resource data and forming the resource control menu, which is then used to provide a single access point for the various system resources. FIG. 11 is a flowchart illustrating an exemplary resource gathering and control process 400 of the present technique. As illustrated, the process 400 proceeds by starting the system, which may be any desired computer system or device (block 402). As the system is initialized, the process 400 acquires various settings and properties for a quick resource control menu, such as menu 180 (block 404). For example, the process 400 may acquire existing options, operational parameters, and other settings of the quick resource control menu from the operating system (e.g., the registry of Microsoft Windows, which is a product of Microsoft Corporation of Redmond, Wash.). The process 400 then proceeds to configure the quick resource control menu using the acquired settings (block 406). The process 400 also proceeds to acquire settings of the various system resources listed in the quick resource control menu (block 408). For example, the process 400 may communicate and acquire a variety of hardware and software information from the operating system, the basic input/output system (“BIOS”), device drivers such as audio and video drivers, and directly from the various hardware and software applications. The system resource information acquired by the process 400 is then used to enable functional control of the system resources using the quick resource control menu (block 410).

Rather than requiring independent access of each system resource through various software menus and links, the quick resource control menu provides a single access point for all the desired resources and control functions. The process 400 also simplifies the access and control of the system resources by activating one or more quick access links to the resource control menu (block 412). For example, as discussed above, the present technique may provide one or more digitizer-activated buttons, quick access software buttons (e.g., one click software buttons), voice activation mechanisms, or touch buttons on the tablet computing device 12. Accordingly, a single click of the appropriate button or menu trigger launches the foregoing quick resource control menu, which only requires a single selection of a desired resource control item to initiate the desired resource control operation.

After configuring and enabling the quick resource control menu, the process 400 awaits user access of the quick resource control menu (block 414). As noted above, the user may speak a particular voice command, touch a screen button, touch a mechanical button, tap the digitizing pointing device 16 on a screen button or other digitizer-activated button, or perform any other menu-activating process. If the user triggers one of the foregoing quick access links at block 416, then the process 400 displays the quick resource control menu (block 418). The process 400 then awaits user selection of the desired resource/function listed on the resource control menu (block 420). If the user does not select a desired resource/function at block 422, then the process 400 closes the quick resource control menu (block 424). If the user selects a desired resource/function at block 422, then the process 400 proceeds to execute the selected resource control (block 426).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims. For example, the present technique may utilize a variety of menu structures, resource communication methods, and menu activation and triggering mechanisms. The present technique is also applicable to any suitable operating system, system architecture, and computer system, including desktop computers, laptop computers, palmtop computers, and tablet computers.

What is claimed is:

1. A method for controlling resources of a computing device, comprising the acts of:
acquiring resource data for a plurality of system resources of the computing device;
forming a resource control menu listing the plurality of system resources; and
providing a quick-access launching mechanism to launch the resource control menu.

2. The method of claim 1, wherein the act of acquiring resource data comprises the act of retrieving hardware operational data.

3. The method of claim 2, wherein the act of retrieving hardware operational data comprises the act of obtaining existing hardware settings.

4. The method of claim 1, wherein the act of acquiring resource data comprises the act of extracting a portion of the resource data directly from the plurality of system resources.

5. The method of claim 1, wherein the act of acquiring resource data comprises the act of extracting a portion of the resource data from BIOS of the computing device.

6. The method of claim 1, wherein the act of forming the resource control menu comprises the act of linking a hardware control utility to at least one menu item in the resource control menu.

7. The method of claim 1, wherein the act of forming the resource control menu comprises the act of assigning a hardware control function to at least one menu item in the resource control menu.

8. The method of claim 1, wherein the act of forming the resource control menu comprises the act of creating a plurality of one-stage control triggers for the plurality of system resources.

9. The method of claim 8, wherein the act of creating the plurality of one-stage control triggers comprises the act of defining digitizer-activated buttons.

10. The method of claim 1, wherein the act of providing the quick-access launching mechanism comprises the act of associating the resource control menu with a digitizer-activated launch button.

11. The method of claim 1, wherein the act of providing the quick-access launching mechanism comprises the act of associating the resource control menu with a one-click software button.

12. The method of claim 1, comprising the act of disposing the resource control menu and the quick-access launching mechanism on a tablet computer.

13. A method for controlling resources of a computing device, comprising the acts of:
launching a resource control menu listing a plurality of resource control options for the resources; and
selecting a desired one of the plurality of resource control options to initiate resource control.

14. The method of claim 13, wherein the act of launching comprises the act of engaging a software button displayed on the computing device.

15. The method of claim 13, wherein the act of launching comprises the act of tapping a digitizer-activated button on the computing device with a digitizing pointing device.

16. The method of claim 13, wherein the act of launching comprises the act of depressing a electromechanical button disposed on the computing device.

17. The method of claim 13, wherein the act of launching comprises the act of accessing links to a plurality of hardware configuration utilities.

18. The method of claim 13, wherein the act of selecting comprises the act of tapping the desired one with a digitizing pointing device.

19. The method of claim 13, wherein the act of selecting comprises the acts of:
scrolling through the plurality of resource control options with a menu scrolling mechanism disposed on the computing device; and
selecting the desired one with a menu item selection button disposed on the computing device.

20. The method of claim 13, wherein the act of selecting comprises the act of touching a touch-activated screen-area of the resource control menu.

21. The method of claim 13, wherein the act of selecting comprises the act of toggling a hardware setting of the computing device.

22. The method of claim 13, wherein the act of selecting comprises the act of activating a hardware configuration utility for the desired one.

23. The method of claim 18, wherein the act of activating comprises the act of interacting with the hardware configuration utility to edit operational properties of the desired one.

24. A system for controlling resources of a computing device, comprising:
a resource control menu listing a plurality of system resources; and
a quick-access launching mechanism linked to the resource control menu.

25. The system of claim 24, wherein the resource control menu comprises a launching link to a hardware configuration utility for at least one of the plurality of system resources.

26. The system of claim 24, wherein the resource control menu comprises a toggle for a hardware setting of at least one of the plurality of system resources.

27. The system of claim 24, wherein the resource control menu comprises a hardware configuration routine for at least one of the plurality of system resources.

28. The system of claim 24, wherein the quick-access launching mechanism comprises a digitizer-activated button.

29. The system of claim 24, wherein the quick-access launching mechanism comprises an electromechanical button disposed on the computing device.

30. The system of claim 24, wherein the quick-access launching mechanism comprises a continually-visible software button.

31. The system of claim 24, wherein the resource control menu and the quick-access launching mechanism are disposed on a tablet computing device.

32. A system for controlling resources of a computing device, comprising:
multi-resource control means for configuring a plurality of system resources of the computing device; and
launching means for initiating the multi-resource control means.

33. The system of claim 32, comprising means for analyzing operational characteristics of the plurality of system resources.

34. The system of claim 32, wherein the plurality of system resources comprise hardware components of the computing device.

35. The system of claim 32, wherein the multi-resource control means and the launching means are disposed on a tablet computing device.

36. A computer system, comprising:
a tablet computing device having a plurality of system resources;
a resource control menu listing the plurality of system resources; and
a launching mechanism linked to the resource control menu.

37. The computer system of claim 36, wherein the plurality of system resources comprise hardware components.

38. The computer system of claim 37, wherein the hardware components comprise audio/video components.

39. The computer system of claim 36, wherein the plurality of system resources comprise software applications.

40. The computer system of claim 39, wherein the software applications comprise hardware configuration utilities.

41. The computer system of claim 40, wherein the hardware configuration utilities comprise a display orientation utility having a plurality of different viewing orientations for a display of the tablet computing device.

42. The computer system of claim 40, wherein the hardware configuration utilities comprise a tablet computer configuration utility.

43. The computer system of claim 40, wherein the hardware configuration utilities comprise a digitizer pen configuration utility.

44. The computer system of claim 40, wherein the hardware configuration utilities comprise a mobile power configuration utility.

45. The system of claim 36, wherein the resource control menu comprises a link to a resource configuration utility for at least one of the plurality of system resources.

46. The system of claim 36, wherein the resource control menu comprises a toggle for a hardware setting of at least one of the plurality of system resources.

47. The system of claim 36, wherein the launching mechanism comprises a digitizer-activated button.

48. The system of claim 36, wherein the launching mechanism comprises a electromechanical button disposed on the tablet computing device.

49. The system of claim 36, wherein the launching mechanism comprises a software button.

50. The system of claim 49, wherein the software button is continually visible in a display screen of the tablet computing device.

51. A method for configuring hardware of a portable computing device, comprising the acts of:
acquiring hardware data for a plurality of hardware components of the portable computing device;
forming a hardware configuration menu listing the plurality of hardware components; and
providing a user access mechanism to launch the hardware configuration menu.

52. The method of claim 51, wherein the act of acquiring hardware data comprises the act of obtaining existing hardware settings of the plurality of hardware components.

53. The method of claim 51, wherein the act of acquiring hardware data comprises the act of extracting a portion of the hardware data from an operating system of the portable computing device.

54. The method of claim 51, wherein the act of forming the hardware configuration menu comprises the act of linking a hardware configuration utility to at least one menu item in the hardware configuration menu.

55. The method of claim 51, wherein the act of forming the hardware configuration menu comprises the act of providing a hardware configuration toggle in the hardware configuration menu.

56. The method of claim 51, comprising the act of disposing the hardware configuration menu and the user access mechanism on a tablet computer.

57. The method of claim 51, wherein the act of providing the user access mechanism comprises the act of placing an access button on the portable computing device in a continually accessible location during operation.

58. The method of claim 57, wherein the act of placing the access button comprises the act of displaying a software button on a display screen of the portable computing device.

59. A system for configuring hardware components of a computing device, comprising:
a hardware interface menu listing a plurality of hardware components;
a hardware configuration mechanism linked to each listed component of the plurality of hardware components; and
a user access mechanism linked to the hardware interface menu.

60. The system of claim 59, wherein the hardware configuration mechanism comprises a hardware configuration toggle.

61. The system of claim 59, wherein the hardware interface menu comprises a hardware configuration routine.

62. The system of claim 59, wherein the hardware configuration mechanism comprises a hardware configuration application having a user interface.

63. The system of claim 59, wherein the user access mechanism comprises a digitizer-activated button.

64. The system of claim 59, wherein the user access mechanism comprises an electromechanical button disposed on the computing device.

65. The system of claim 59, wherein the user access mechanism comprises a button disposed on the computing device in a continually accessible location during operation of the computing device.

66. The system of claim 65, wherein the button comprises a software button disposed on a display screen of the computing device.

67. The system of claim 59, wherein the hardware interface menu and the user access mechanism are disposed on a tablet computing device.
